(19) United States
(12) Patent Application Publication
(10) Pub. No.: US 2007/0074175 A1
(43) Pub. Date: Mar. 29, 2007

(54) Method and system for dynamic probes for injection and extraction of data for test and monitoring of software

(75) Inventors: Jonas Bengtsson, Landskrona (SE); Michael Rosenberg, Sodra Sandby (SE)

Correspondence Address: ERICSSON INC., 6300 LEGACY DRIVE, M/S EVR 1-C-11, PLANO, TX, 75024, US

(73) Assignee: Telefonaktiebolaget L M Ericsson (publ), Stockholm (SE)

(21) Appl. No.: 11/234,846

(22) Filed: Sep. 23, 2005

(51) Int. Cl. G06F 9/44

(52) U.S. Cl. 717/130; 717/124

(57) ABSTRACT

Method and system are disclosed for dynamic probing of software. The dynamic probe is capable of being inserted into (or removed from) the software under test during run-time. This dynamic insertion (and removal) of the probe allows the user to insert and remove probes as needed instead of recompiling the software in order to insert new probes. Also, the dynamic insertion (and removal) of probes saves memory space by allowing the user to add probes only as needed and to remove probes that are no longer being used. This Abstract is submitted with the understanding that it will not be used to interpret or limit the scope or meaning of the claims. 37 CFR 1.72(b).

### BACKGROUND

1. Technical Field

The invention is related to testing of software and, in particular, to a method for dynamic probing of software.

2. Description of Related Art

Among developers of software, one of the most important requirements is for the software to be reliable. Reliability refers to the ability of software to operate without failure for a specified amount of time in a specified environment. To ensure a sufficiently high level of reliability, software must be thoroughly tested and debugged prior to release. Usually, the entire software program as a whole is tested, as well as the individual functional components (e.g., function calls, subroutines) that make up the software program. Typically, test vectors are generated containing a series of values for the variables that are required by the software and/or one or more functional components. The variable values are chosen to represent various types of usage conditions and environments in which the software is intended to be run. The test vectors are then applied to the software and/or the one or more functional components, and the variable values are observed and recorded.

One type of testing that is often performed is called regression analysis, or sometimes verification testing. Regression analysis involves the selective retesting of software that has been modified in order to fix known problems. The selective retesting is performed in order to ensure that the identified problems have been fixed, and that no other previously working functional components have failed as a result of the reparations. This type of testing is basically a quality control measure to ensure that the modified code still complies with its specified requirements and that any unmodified code has not been affected by the maintenance activity.

An important feature in regression analysis specifically and in software testing in general is the ability to observe the variable values resulting from the test vectors. Early attempts to observe the variable values of software and/or the functional components thereof involved manually setting break points and other traps in the source code itself. More recently, software development tools such as Code Composer Studio™ from Texas Instruments and LabVIEW™ from National Instruments include software probes that may be inserted into the code under test. The software probes allow the variables in the code under test to be observed in real-time as the software is executed. These latter solutions, however, are based only on getting the variable values out from the code under test (e.g., so they can be analyzed). They do not allow the variable values to be changed during the execution of the software. In other words, these existing software probes are only one-way or unidirectional probes in that the data is allowed to flow only from the code under test to the test system. They do not allow the direction of data transfer to be reversed so that data flows from the test system into the code under test.

Other probes are bi-directional in that the probes allow data to flow from the code under test to the test system and vice versa. An example of a bi-directional probe may be found in commonly-owned U.S. application Ser. No. 10/428733, entitled “BI-DIRECTIONAL PROBING OF SOFTWARE,” filed on May 1, 2003, which is hereby incorporated by reference.

In existing solutions, however, both unidirectional and bi-directional probes operate in static mode, meaning that the probes need to be determined during the compile time of the software under test. If the probe is not introduced during the compile time, the only way to introduce the probe is to rebuild the software under test, which is undesirable. Also, even while a probe is inactive, it still consumes a small amount of memory, which may add up to a significant amount of memory for an entire system.

Therefore, there is a need for a probe that can be installed into the software under test during run-time instead of compile time, such that the probes can be introduced and removed as needed and only installed probes consume memory.

### SUMMARY OF THE INVENTION

A method of testing software having a plurality of software modules therein is provided. The method includes executing the software, including the plurality of software modules used by the software and identifying two of the plurality of software modules that are directly linked to one another. A probe is inserted between the two identified software modules while the software is being executed. The probe outputs data being exchanged between the two identified software modules to a test system to thereby extract data from the software.

According to another embodiment of the present invention, a system for testing software is provided. The system includes a software under test, the software having a plurality of software modules therein. At least one application is coupled to the software under test. A tester unit controls the at least one application, such that the tester unit is configured to cause the at least one application to execute the software under test, including any software modules used by the software under test. The tester unit is also configured to identify two of the software modules used by the software under test that are in direct communication with one another, insert a probe between the two identified software modules while the software under test is being executed, and output data being exchanged between the two identified software modules via the probe to thereby extract data from the software under test.

According to yet another embodiment of the present invention, a method of testing software having a plurality of software modules therein is provided. The method includes requesting a probe for the software while the software is being executed and obtaining a handle to the probe from the component manager. Two of the plurality of software modules to be tested are identified and the two identified software modules directly linked to one another. The handle of the probe is inserted between the two identified software modules.

According to another embodiment of the present invention, an apparatus for testing software having a plurality of data variables and function arguments therein is provided. The apparatus includes a central processing unit and a storage unit connected to the central processing unit. The storage unit stores computer readable instructions for instructing the central processing unit to execute the software and identify an address location for at least one of the variables or arguments used by the software. The storage unit also stores computer readable instructions for instructing the central processing unit to dynamically insert a probe at the address location and output any data stored in the address location to the central processing unit to thereby monitor the data.

According to yet another embodiment of the present invention, a device under test is provided. The device under test includes a plurality of software modules linked in a software chain and a component manager coupled to the software modules and for managing the software modules. The software modules are adapted to be separated and realigned during use, such that a probe can be inserted between two of the plurality of software modules during operation of the software.

According to another embodiment of the present invention, a method of testing software having a plurality of software modules therein is provided. The method includes creating software probe and receiving a probe identifier, the probe identifier identifying the software probe. A tester is instructed to insert or remove the software probe in the plurality of software modules. A confirmation that the software probe has been inserted or removed is also received.

According to yet another embodiment, a method of testing software having a plurality of software modules therein is provided. The method includes obtaining a handle to a probe and placing a probe identifier in a probe database. The probe identifier is returned to a personal computer. An instruction to insert or remove the probe in the plurality of software modules is received and the plurality of software modules are rearranged. The status of the probe in the plurality of software modules is confirmed and a message confirming the placement of the probe to the personal computer is transmitted.

### BRIEF DESCRIPTION OF THE DRAWINGS

A better understanding of the invention may be had by reference to the following detailed description when taken in conjunction with the accompanying drawings, wherein:

FIG. 1a illustrates an exemplary software testing environment according to embodiments of the invention;

FIG. 1b illustrates a schematic of a dynamic probe inserted between software modules of FIG. 1a;

FIG. 1c illustrates a schematic of the software modules of FIG. 1a without a probe inserted therebetween;

FIG. 2 illustrates a method of implementing the dynamic software probe according to embodiments of the invention; and

FIG. 3 illustrates an exemplary system in which the bi-directional software probe according to embodiments of the invention may be implemented.

### DESCRIPTION OF ILLUSTRATIVE EMBODIMENTS OF THE INVENTION

As alluded to above, existing unidirectional and bi-directional probes lack flexibility in that the probes need to be determined during the compile time of the software under test (SUT). Otherwise, the only way to introduce a probe is to rebuild the whole SUT. Also, even if not activated, each probe consumes a small amount of memory and can therefore add up to a considerable amount given the number of probes that may need to be used.

Embodiments of the invention provide a method and system for testing software using dynamic probes. The dynamic probes of the invention do not need to be inserted during the compilation of the software, but instead are capable of being inserted during the runtime of the software. Introducing a probe into an SUT during runtime has several advantages, including limiting the insertion to only those probes that are actually needed, thereby decreasing the use of expensive memory and CPU cycles. Further, it is possible to introduce a probe essentially anywhere in the SUT where there is a communication chain (COM chain). The dynamic probes thus greatly improve flexibility in both testing and debugging of the SUT. Further, the probes are bi-directional, meaning that they allow data to flow both from the SUT to the test system and vice versa.

In a preferred embodiment, the software being probed is also dynamic in that it can be linked during runtime to other, already existing software modules. The dynamic linking allows an entire chain of software modules to be linked together or “built” during runtime.

Within the platform, a linking mechanism is used to perform the linking of the software modules. Other similar linking mechanisms include, for example, Microsoft COM and other proprietary COM systems. While these linking mechanisms use a type of control software to handle the actual linking, the specific software modules that are linked, and the order in which they are linked, are dictated by the customer applications that run on top of the platform. If the user wants to change the way the software modules are chained, he or she must do so through the applications above the platform. Therefore, the control software has to export that functionality to the customer applications via the platform.

In accordance with embodiments of the invention, a chain of software modules operating on a data stream may be “broken up” and a dynamic test and verification platform (TVP) probe introduced between them. As used herein, the terms “link” and “chain” refer to ability of the software modules to exchange data and otherwise communicate with one another. To create a dynamic probe, the customer application, on the personal computer (PC) creates the dynamic probe with the TVP database, which returns a unique ID. The TVP database then asks the component manager for a handle or link to the dynamic probe. The customer PC application then instructs the TVP to instruct the control software to rearrange the software module chain so that the dynamic probe is a part of the chain at the desired location. Once in place, the dynamic probe is handled by the test system in the same way as the static probes mentioned above. Thereafter, the user of the test system may inject data in or probe data out from the new dynamic probe. If a dynamic probe is to be removed, the procedure described above is performed in reverse.

In some embodiments, the software modules may have interfaces that are unknown to the dynamic probe. Therefore, in order to introduce a dynamic probe between such software modules, the interface of the dynamic probe is preferably designed to be a general interface, as explained further below. The interpretation of the data is then left to the customer application that is running on the PC.

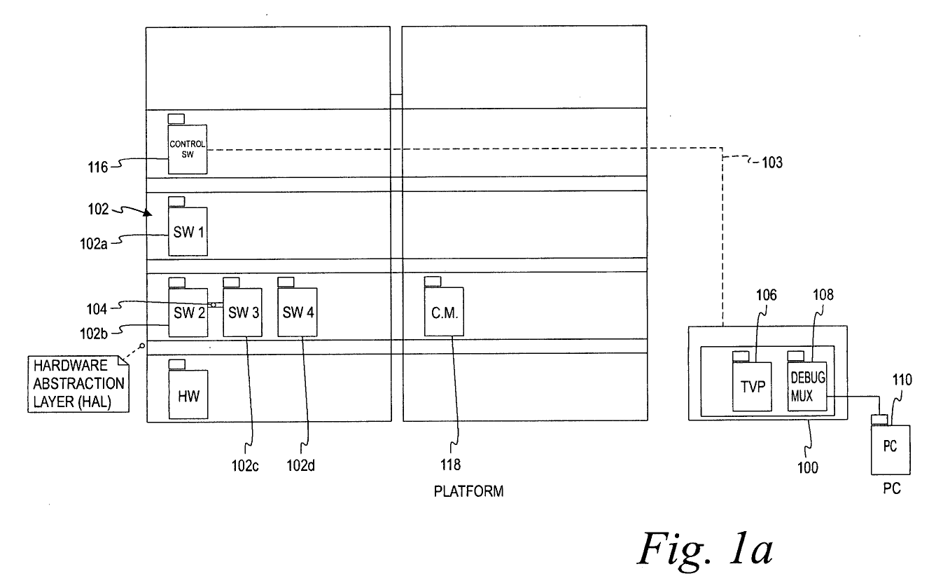

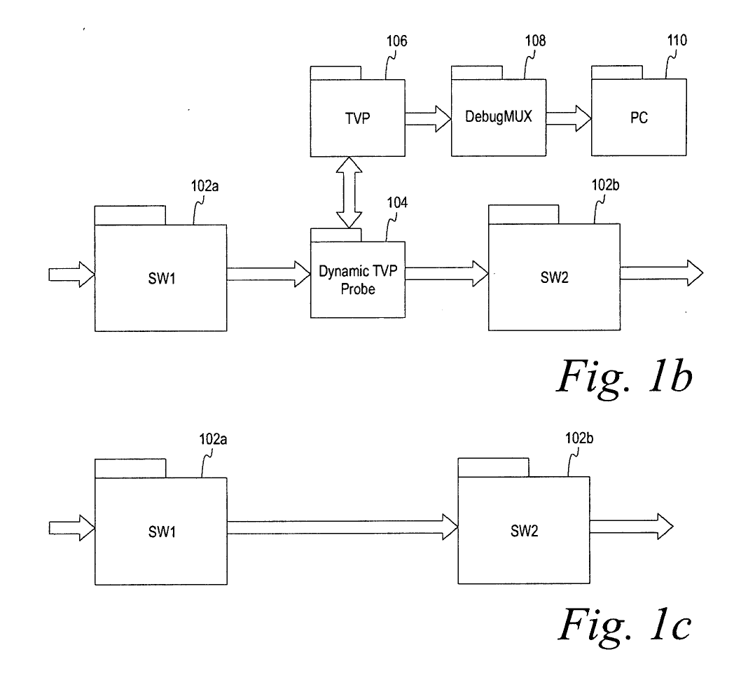

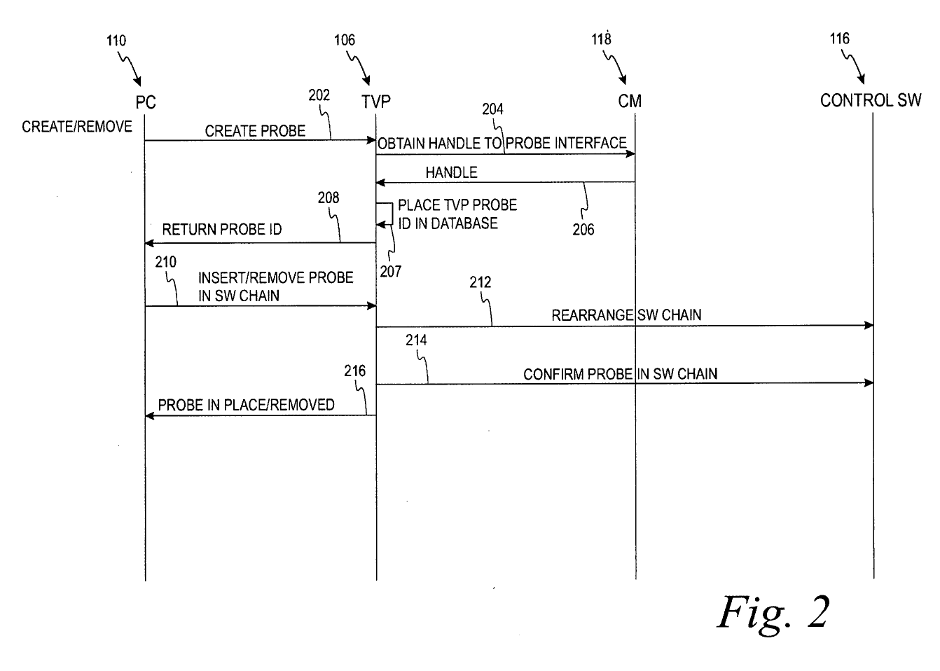

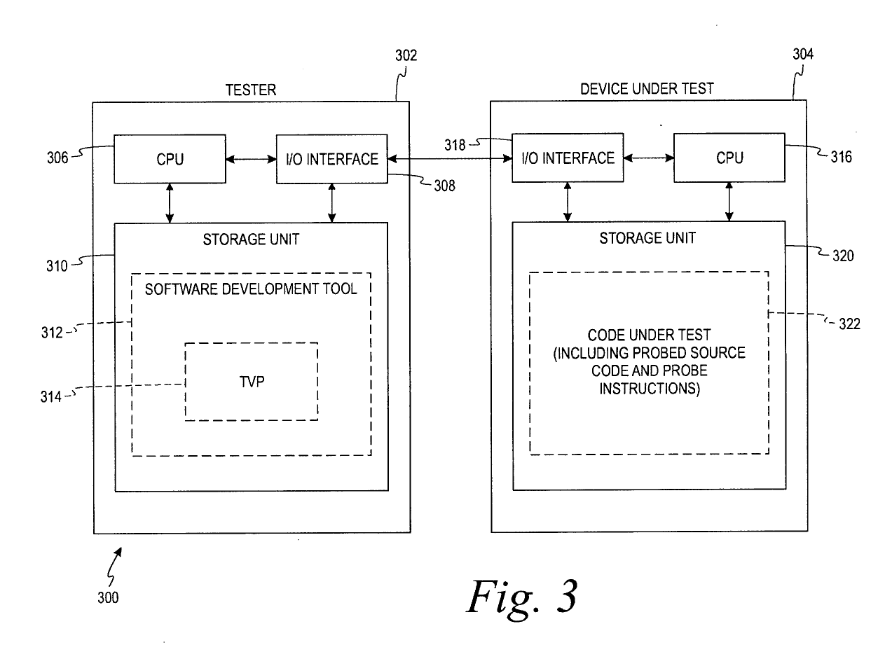

Referring first to FIG. 1a, a software test system 100 is shown in which the dynamic probing technique of the present invention may be used. The software test system 100 is connected to an SUT 102 via at least one software dynamic probe 104. The at least one software dynamic probe 104 may be identified by its unique probe ID, for example, PID 1, PID 2, PID 3, and so on. The generation of the probe IDs will be described below in more detail with respect to FIG. 2.

The dynamic probe 104 is connected to a test and verification platform (TVP) 106 (which may be a proprietary TVP or a standard TVP known to persons having ordinary skill in the art). The TVP 106, in turn, is coupled to other test modules, such as, but not limited to, a debug mux 108. The debug mux 108, in turn, is connected to a personal computer (PC) 110. The debug mux 108 receives all the communications from the PC 110 and transfers the communications to the TVP 106. The PC 110 controls all the testing.

The SUT 102 includes a number of separate software modules 102a, 102b, 102c, 102d, four of which are illustrated in FIG. 1. These software modules 102a, 102b, 102c, 102d include a plurality of data variables and function arguments, such as, but not limited to, encoders, equalizers, general filters, and the like. The software modules 102a, 102b, 102c, 102d must be able to be dynamically linked to each other. In other words, the software modules 102a, 102b, 102c, 102d are able to be maneuvered during the compile time. This allows the chain of software modules 102a, 102b, 102c, 102d to be broken apart during run-time.

The dynamic probe 104 is able to be dynamically placed in between any of these software modules 102a, 102b, 102c, 102d. Dynamically placing the dynamic probe 104 means that the dynamic probe 104 can be inserted in between the software modules 102a, 102b, 102c, 102d during the run-time instead of the compile time of the software 102. The dynamic probe 104 may also be removed during runtime. By allowing the placement and removal of the dynamic probe 104 during run-time, extraneous probes are not needed and memory space may be conserved.

In some embodiments, the dynamic probe 104 may be inserted between software modules with interfaces having multiple parameters. For these modules, the dynamic probe 104 preferably has a general interface. A general interface is one that only requires two parameters: the length of the data and the pointer to the data. Other parameters, such as the bit rate and the sampling frequency can be hidden in the data. The probe does not need to have these other, more specific parameters.

The general interface is preferably designed to allow, among other things, data to be extracted from, and injected into, the software modules 102a, 102b, 102c, 102d. The general interface preferably also includes the probe ID and a pointer to the data that is t6 be injected into, or extracted from, the software modules 102a, 102b, 102c, 102d. The general interface preferably further includes a way to facilitate the creating and deleting of the probe 104.

Referring now to FIG. 1b, an illustration of the dynamic probe 104 inserted between the software modules 102a and 102b is provided. As illustrated the probe 104 is inserted between the two software modules 102a and 102b and communicates with the TVP 106. The TVP 106 is also coupled to the Debug MUX 108, as described above in conjunction with FIG. 1a. The Debug MUX 108 is also coupled to the PC 110.

FIG. 1c illustrates the software modules 102a, 102b with the probe 104 removed. As shown, the software modules 102a, 102b are coupled to each other.

Referring now to FIG. 2, a method for registering a dynamic probe according to one embodiment of the invention will be described. As shown, the PC 110 creates the probe with the TVP 106 (step 202). The TVP 106 then communicates with the component manager 118 to obtain the handle to the probe interface (step 204). The component manager 118 then sends the handle to the TVP 106 (step 206), which then places the TVP probe 104 in the database (step 207). At step 208, the TVP 106 then returns the probe ID to the PC 110.

The PC 110 then sends an instruction to the TVP 106 as to whether the probe should be inserted or removed in the software chain at step 210. The TVP 106 then forwards the instruction to the control software 116, which rearranges the software chain (step 212). The control software 116 confirms that the probe is in the software chain (or has been removed) at step 214. At step 216, the TVP 106 then communicates with the PC 110 as to the placement (or removal) of the probe.

The dynamic probing technique of the present invention may be implemented in any test system. FIG. 3 shows an exemplary test system 300 for implementing the dynamic probing technique. The test system 300 includes a tester 302 and a device under test 304 that are in communication with each other. The tester 302 is a typical computer that has a number of functional components, including a CPU 306, an input/output interface unit 308, and a storage unit 310. These components are well known to people of ordinary skill in the computer art and will therefore be described only briefly here. The CPU 306 handles the execution of all software programs on the tester 302, including the operating system and any software running thereon. The interface unit 308 serves to interface the tester 302 to the device under test 304, as well as any input/output devices (e.g., keyboard, mouse, display unit, printer, etc.) connected thereto. The storage unit 310 provides temporary storage (e.g., RAM) and/or long-term storage (e.g., hard drive) for any software programs and/or data that may be needed for the execution of the operating system and the software running on the tester 302.

Stored in the storage unit 310 are a number of software applications, including a software development tool 312. The software development tool 312 operates in the same way and has many of the same features as existing software development tools such as Code Composer Studio™. from Texas Instruments and LabVIEW.TM. from National Instruments, or other similar software development tools. In accordance with embodiments of the invention, however, the software development tool 312 further includes a test and verification platform (TVP) 314. The TVP 314 is capable of controlling the bi-directional probing of any software being tested using the software development tool 312, and analyzing the data being probed. Specifically, the TVP 314 allows data to be captured from the code under test, injected into the code under test, or both, as determined by a user. The probe control and analysis module 314 also allows the user to generate test vectors based on the data obtained and to inject the test vectors back into the code under test. This makes it easier and more convenient for the user to monitor and test the operation and reliability of the code under test.

In the present embodiment, the code under test, including the dynamic probe instructions, is executed on a separate unit, namely the device under test 304, that is in communication with the tester 302. The device under test 304, like the tester 302, is a typical computer that has a number of functional components, including a CPU 316, an input/output interface unit 318, and a storage unit 320. The components of the device under test 304 are similar in function to their counterparts in the tester 302 and will therefore not be described here. The main point is that the code under test 322, including the probed source code and the dynamic probe instructions and implementation is stored and executed separately from the tester 302. (See the exemplary blocks of source code above for examples of probe instructions.)

The above described method allows the probe to be inserted in real time, which gives the person performing the test flexibility to insert the probes when they are needed. Also, because the probes are removable, memory can be saved by removing inactive probes or after a probe has performed the desired test.

It should be emphasized that the term comprises/comprising, when used in this specification, is taken to specify the presence of stated features, integers, steps, or components, but does not preclude the presence or addition of one or more other features, integers, steps, components, or groups thereof.

While particular embodiments and applications of the present invention have been illustrated and described, it is to be understood that the invention is not limited to the precise construction and compositions disclosed herein, and that modifications and variations may be made to the foregoing without departing from the scope of the invention as defined in the appended claims.

What is claimed is:

1. A method of testing software having a plurality of software modules therein, comprising:
executing the software, including the plurality of software modules used by the software;
identifying two of the plurality of software modules that are directly linked to one another;
inserting a probe between the two identified software modules while the software is being executed; and
outputting data being exchanged between the two identified software modules to a test system via the probe to thereby extract data from the software.

2. The method according to claim 1, further comprising removing the probe between the two identified software modules while the software is being executed.

3. The method according to claim 1, wherein the probe includes a unique probe identifier.

4. The method according to claim 3, wherein the unique probe identifier is assigned to the probe prior to testing of the software and stored in a probe database.

5. The method according to claim 3, wherein the unique probe identifier is created during testing of the software.

6. The method according to claim 3, wherein the unique probe identifier is stored in a probe database.

7. The method according to claim 1, further comprising replacing data to be exchanged between the two identified software modules with data from the test system via the probe to thereby inject data into the software.

8. The method according to claim 1, wherein the probe includes a general interface that allows the probe to extract data from and inject data into software modules using only the length of the data and the pointer to the data.

9. The method according to claim 1, further comprising linking the plurality of software modules together while the software is being executed.

10. A system for testing software, comprising:
a software under test, the software having a plurality of software modules therein;
at least one application coupled to the software under test; and
a tester unit controlling the at least one application, the tester unit configured to cause the at least one application to:
execute the software under test, including any software modules used by the software under test;
identify two of the software modules used by the software under test that are in direct communication with one another;
insert a probe between the two identified software modules while the software under test is being executed; and
output data being exchanged between the two identified software modules via the probe to thereby extract data from the software under test.

11. The system according to claim 10, wherein the tester is further configured to cause the at least one application to remove the probe from between the two identified software modules while the software under test is being executed.

12. The system according to claim 10, wherein the tester is further configured to cause the at least one application to replace data being exchanged between the two identified software modules via the probe to thereby inject data into the software under test.

13. The system according to claim 10, wherein the tester unit includes a test and verification platform for controlling the at least one application.

14. The system according to claim 10, wherein the at least one application runs on a PC.

15. A method of testing software having a plurality of software modules therein, comprising:
requesting a probe for the software while the software is being executed;
obtaining a handle to the probe from the component manager;
identifying two of the plurality of software modules to be tested, the two identified software modules directly linked to one another; and
inserting the handle of the probe between the two identified software modules.

16. The method according to claim 15, further comprising monitoring data extracted from the software via the probe.

17. The method according to claim 15, further comprising removing the handle of the probe from between the two identified software modules while the software is being executed.

18. The method according to claim 15, further comprising deregistering the probe with a probe database while the software is being executed.

19. The method according to claim 15, wherein the two software modules are linked together while the software is being executed.

20. An apparatus for testing software having a plurality of data variables and function arguments therein, comprising:
a central processing unit;
a storage unit connected to the central processing unit, the storage unit storing computer readable instructions for instructing the central processing unit to:
execute the software;
identify an address location for at least one of the variables or arguments used by the software;
dynamically insert a probe at the address location; and
output any data stored in the address location to the central processing unit to thereby monitor the data.

21. The apparatus of claim 20, wherein the storage unit further stores computer readable instructions for instructing the central processing unit to input data from the central processing unit into the address location to thereby replace any data previously stored in the address location.

22. A device under test comprising:
a plurality of software modules linked in a software chain; and
a component manager coupled to the software modules and for managing the software modules;
wherein the software modules are adapted to be separated and realigned during use, such that a probe can be inserted between two of the plurality of software modules during operation of the software.

23. The device under test of claim 22, wherein the probe may also be removed from between two of the plurality of software modules during operation of the software.

24. A method of testing software having a plurality of software modules therein, comprising:
creating software probe;
receiving a probe identifier, the probe identifier identifying the software probe;
instructing a tester to insert or remove the software probe in the plurality of software modules; and
receiving a confirmation that the software probe has been inserted or removed.

25. A method of testing software having a plurality of software modules therein, comprising:
obtaining a handle to a probe;
placing a probe identifier in a probe database;
returning the probe identifier to a personal computer;
receiving an instruction to insert or remove the probe in the plurality of software modules;
rearranging the plurality of software modules;
confirming the status of the probe in the plurality of software modules; and
transmitting a message confirming the placement of the probe to the personal computer.
